(19) United States
(12) Patent Application Publication
(10) Pub. No.: US 2013/0032746 A1
(43) Pub. Date: Feb. 7, 2013

(54) GASKET STRUCTURE FOR FLOOR DRAIN VALVES

(71) Applicant: Kevin Dean Huber, Tacoma, WA (US)

(72) Inventor: Kevin Dean Huber, Tacoma, WA (US)

(21) Appl. No.: 13/362,900

(22) Filed: Jan. 31, 2012

Related U.S. Application Data
(60) Provisional application No. 61/438,074, filed on Jan. 31, 2011.

(51) Int. Cl. F16K 1/42; B23P 17/04

(52) U.S. Cl. 251/359; 29/428

(57) ABSTRACT

An improved gasket for floor drain valve for buildings, basements, exterior paved areas, and the like. The invention provides a gasket positioned around the outside of check valves providing sealing engagement and support for said drain valve within a conduit. The gasket provides outwardly directed vanes for some four and sealing of the valve to the interior of the conduit. In one embodiment the vanes are connected together form an inflatable chamber extending about the periphery of the gasket which cavity is accessed by an inflation needle from the upper surface of said gasket so that air or other gases under pressure may be forced into the inflatable cavity causing the wall of said cavity to engage the interior surface of the conduit thereby sealing and supporting the drain valve. Provision is made for locking the drain valves in operative position within said conduit.

The present disclosure relates valve closures for floor drains. More particularly it relates to gasket structures for valves useful in drains for building floors, basements, exterior paved areas, and the like.

### BACKGROUND

Traditionally, U-shaped or “gooseneck” traps have been used in the plumbing industry to prevent backflow of harmful or undesirable sewer or pipe gasses into buildings while permitting drainage of unwanted liquid from floors and other generally horizontal surfaces. Such traps operate by leaving a small quantity, of fluid within the lower portion of a U-shaped trap section to act as a gas barrier. In many applications, however, particularly where access is difficult or where drainage is infrequent, gooseneck traps are not optimal. Fluid in gooseneck trap may evaporate from the trap, permitting free flow of obnoxious gasses through the drain, insects may breed in the fluid, or in some instances the fluids may harden so as to actually block or restrict flow through the drain. Such conventional drains are also relatively difficult and expensive to install.

Drains with check valves have been developed to overcome some of the shortcomings of the gooseneck traps. See, For example, U.S. Pat. No. 6,273,124 to Huber et al and U.S. Pat. No. 6,719,004 to Huber et al. Such drains are effective in facilitating draining operations and in trapping drain-pipe gasses and preventing backflow. However, check valve type drains with further improvement in their effectiveness, manufacturability, reliability, and ease of use are desirable. Gasket structures which locate, mount and seal the valves in the drain conduits are needed in the industry.

### SUMMARY

The present disclosure provides gaskets for floor drains of improved simplicity and reliability. One embodiment of the present disclosure provides a gasket or a floor drain assembly that includes: a drain basin configured to be inserted into a floor, and a check valve configured to be inserted and secured in the conduit extending downwardly from the lower end of the drain basin. The gaskets provided herein are formed with an interior surface which engages the cylindrical outer surface of the drain valve body and has been structures extending outwardly to engage the interior surface of the conduit. Gaskets providing multiple positioning rings and sealing rings are contemplated to fit in the various drain conduit configurations encountered in the field. Other embodiment of the invention include an inflatable chamber extending around the outer surface of the gasket which may be inflated when the valve body is in place within the conduit thereby engaging and sealing the valve body within the conduit.

The present disclosure also provides a method of installing a cylindrical element within a drain conduit to locate and seal the cylindrical element within the conduit while preventing the backflow of fluids.

### BRIEF DESCRIPTION OF THE DRAWINGS

FIG. 1 is a perspective view of a flapper type valve for use in floor drain assembly according to the present disclosure having the gasket of this invention mounted thereon;

FIG. 2 is a side elevation partly in section of the device shown in FIG. 1 installed in a drain conduit;

FIG. 3 is a top plan view the gasket of FIG. 1;

FIG. 4 is a side view of one embodiment of the gasket of FIG. 1;

FIG. 5 is a bottom plan view the gasket of FIG. 1;

FIG. 6 is a partial cross section of another embodiment of the gasket shown in FIG. 1;

FIG. 7 is an further embodiment of the invention shown in FIG. 1, in which an inflatable chamber extending about the periphery of the gasket is provided to hold the gasket and valve in position in the drain conduit;

FIG. 8 is a cross sectional view of an alternative embodiment of the gasket of FIG. 1 having three flexible fins to engage the interior of the drain conduit;

FIG. 9 is a cross sectional view of a further alternative embodiment of the gasket of FIG. 1 having a single flexible fin to engage the inner wall of the drain conduit;

FIG. 10 is a perspective view of the device shown in FIG. 8;

FIG. 11 is a bottom perspective view of the device shown in FIG. 8.

### DETAILED DESCRIPTION

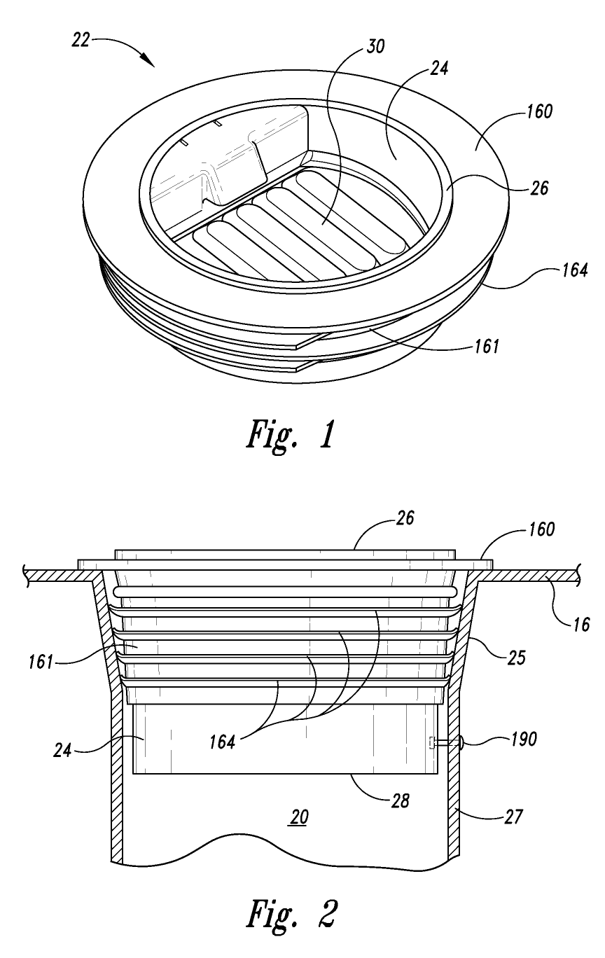

Referring to FIGS. 1 and 2, an embodiment of the gasket for use with floor drain assembly of the present disclosure is described. The floor drain assembly 10 is shown inserted into a floor 12. The assembly includes a drain basin 16 with in inlet 18 and an outlet 20. In the depicted embodiment the inlet 18 is larger than the outlet 20 and both are circular in shape. It should be appreciated that the drain basin 16 can be configured differently in alternative embodiments.

In one embodiment of the gasket of this invention, a check valve assembly 22 is shown adapted to be positioned in a floor drain basin 16. The check valve assembly 22 includes a generally cylindrical body 24, an inlet 26, and an outlet 28. Between the inlet 26 and outlet 28 is a flapper 30 that is configured and arranged to be normally closed against seal surface 44 to prevent gasses from flowing back from the outlet 28 of the cylindrical body 24 through the inlet 26. Whenever water is present on the upper surface of flapper 30, flapper 30 bend downwardly to permit flow of water through the valve structure.

A gasket 160 is used to seal the outer surface of valve body 150 in place within the tapered portion 25 of drain conduit 27. The gasket 161 is shown fitted tightly around the cylindrical valve body 24 and has one or more support vane 164 which engage with and are bent upwardly by insertion into the tapered portion 25, thereby positioning and supporting the valve body 24 in its operative position within conduit 27. Depending on the exact configuration of the tapered portion 25 vanes 164 will be bent upwardly to varying degrees.

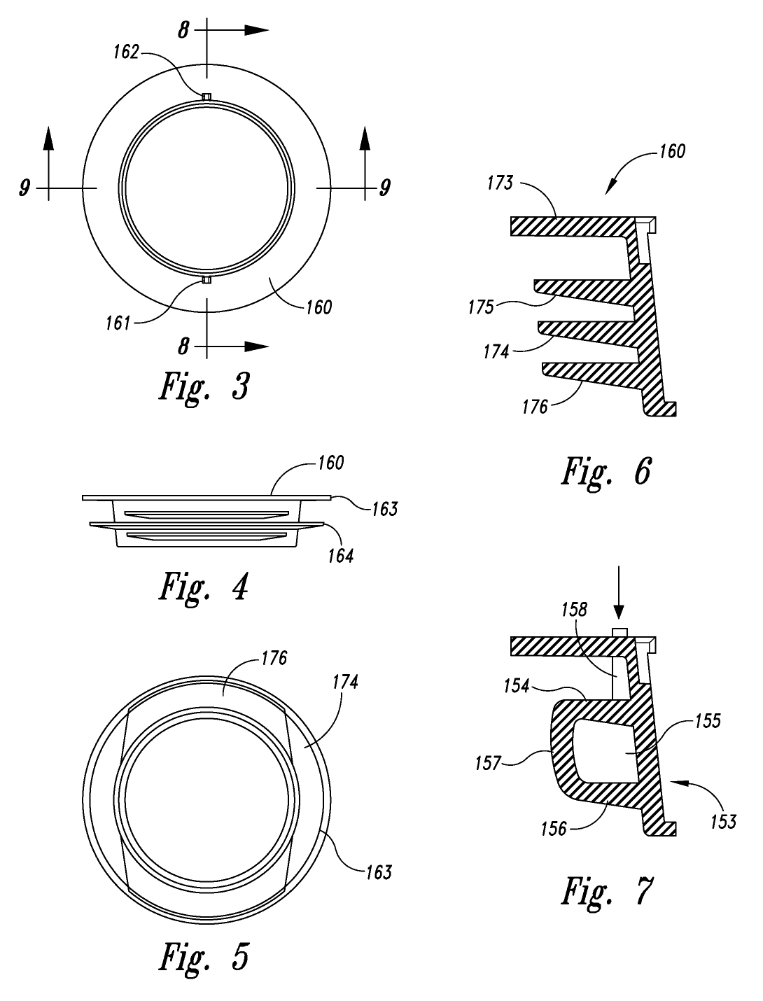

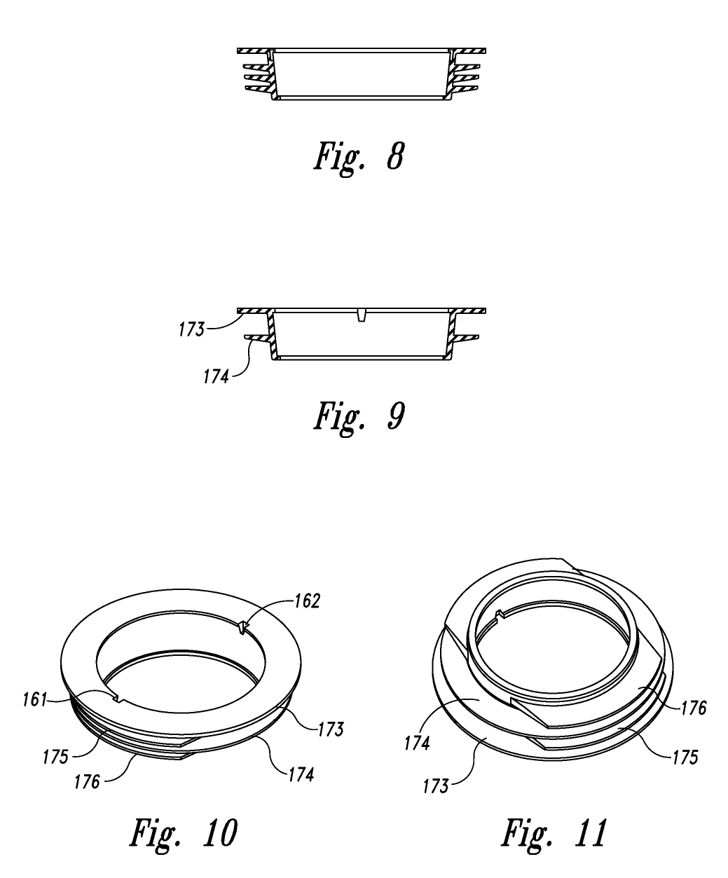

In FIGS. 3-5 and 9, a second embodiment of the invention is shown in which a single vane 164 is used together with partial vanes 176 to seal and position be valve body 24 into conduit 27.

In FIG. 7 alternate embodiment of the gasket of this invention is shown in which an inflatable chamber is formed by joining the tip ends of two vanes with an edge piece 157 to form an inflatable chamber extending about the exterior of gasket 153. An air inlet 158, is shown providing air access into the interior of chamber 155 by use of an air inflation needle such as is utilized in the inflation of a football or basketball. Upon pressurization, the edge piece 157 will be forced outwardly into contact with the tapered portion 25 of conduit 27 (see FIG. 2), thereby supporting and sealing the valve body 24 into its operative position within the tapered portion 25 of conduit 27. If it is desired to remove the valve from the conduit the air inflation needle would be inserted into the inflatable chamber to release the pressure thereby freeing the drain valve to be removed from the conduit.

In some applications it is necessary to insert the valve structure into place through a constricted portion of the conduit. This may be accomplished by separating the gasket 160 from the valve body and compressing, it into an oval shape, inserting it through the constricted area and then re-orienting it in place to receive the valve body. The valve body is then inserted into sealing and operational position within the gasket 160.

In drain structures having an entrance diameter less that the total diameter of the valve structure with gasket installed, but with an enlarged portion downstream the valve may be installed by first inserting the gasket, flexed into an oval shape into the enlarged portion of the drain structure, orienting the gasket to receive the valve body and then inserting the valve body, now inside the drain structure, into the gasket. The assembled gasket and valve body is then thrust downwardly into its operative position within the drain conduit.

The above specification, examples and data provide a complete description of the manufacture and use of the composition of the invention. Since many embodiments of the invention can be made without departing from the spirit and scope of the invention, the invention resides in the claims hereinafter appended.

I claim:

1. A gasket for a floor drain valve, said floor drain out having a cylindrical outer surface and a valve structure positioned between an inlet and outlet and being adapted a positioned into the entrance of a drain conduit, said gasket comprising:
a. a cylindrical portion adapted to fit tightly about said cylindrical outer surface of said drain valve;
b. an upper lip on said cylindrical portion extending outwardly therefrom and adapted to engage said drain conduit entrance; and
b. at least one flexible vane extending outwardly around the circumference of said cylindrical portion, said at least one vane adapted to engage the interior of said drain conduit to support and seal said valve therein.

2. The gasket of claim 1 having two flexible vanes extending outwardly around the circumference of said cylindrical portion.

3. The gasket of claim 1 having three flexible vanes extending outwardly around the circumference of said cylindrical portion.

4. The gasket of claim two wherein said to flexible vanes are connected together to form a toroidal cavity extending around the exterior of said cylindrical portion; and an access port in said upper left extending into said toroidal cavity for receiving an inflation needle to inflate said toroidal cavity when said gasket and valve structure are position within said conduit.

5. The gasket of claim one wherein locking means are provided to lock said valve structure in place within said conduit.

6. A method of installing a drain valve into a conduit said drain valve having a substantially cylindrical outer surface and having a gasket positioned thereon said gasket having a plurality of flexible vanes extending outwardly from the external surface thereof said method comprising:
a. inserting said drain valve having gasket thereon into the drain conduit said flexible vanes engaging said conduit and positioning said valve concentrically within said conduit and sealing said valve therein precluding passage of fluids upwardly from said conduit; and
b. locking said valve in its operative position to prevent said valve from being ejected from said conduit by pressure in said conduit.

7. The method of claim six wherein said plurality of vanes are connected together to form an inflatable chamber and further including the step of inflating said chamber to expanded outwardly into contact with said conduit.

8. A method of installing drain valves in drain structures having an entrance diameter less that the total diameter of the valve structure with gasket installed, and having an enlarged portion downstream, comprising the steps of:
inserting the gasket, flexed into an oval shape, into the drain;
orienting the gasket to receive the valve body;
inserting the valve body, now inside the drain structure, into the gasket, and;
thrusting the assembled valve body and gasket downwardly into its operative position within the drain conduit.

9. The method of claim 8 further including the step of locking said drain valve body to send drain structure to preclude exit of said valve body under pressure within said conduit.
